(19) United States
(12) Patent Application Publication
(10) Pub. No.: US 2026/0340205 A1
(43) Pub. Date: Oct. 29, 2026

(54) Displayed Content Privacy

(71) Applicant: Microsoft Technology Licensing, LLC, Redmond, WA (US)

(72) Inventors: Shankar Gomathi BALASUBRAMANIAN, Issaquah, WA (US); Aakanksha CHHAVI, Bengaluru (IN); Kari Jussi ROPO, Espoo (FI); Nobuyuki SUZUKI, Kirkland, WA (US); Fizalkhan PEERMOHAMED, Maple Valley, WA (US)

(73) Assignee: Microsoft Technology Licensing, LLC, Redmond, WA (US)

(21) Appl. No.: 19/193,732

(22) Filed: Apr. 29, 2025

(51) Int. Cl. G06F 21/84; G06F 21/62; G09G 5/00

(52) U.S. Cl. CPC G06F 21/84; G06F 21/6245; G09G 5/006; G09G 2320/068; G09G 2358/00

(57) ABSTRACT

The description relates to enhancing privacy of visual content displayed for a user. One example can identify an electronic privacy (E-privacy) filter capability on a display of a device. The example can surface the E-privacy filter capability for control by an entity presenting content on the display.

### BACKGROUND

Computer users spend hours every day looking at content displayed by their computing devices, such as notebook computers, smartphones, etc. In many work settings and especially public settings, content intended and displayed for a user is visible to other people in the user's vicinity.

### SUMMARY

The present disclosure relates to enhancing privacy of visual content displayed for a user. One example can identify an electronic privacy (E-privacy) filter capability on a display of a device. The example can surface the E-privacy filter capability for control by an entity presenting content on the display.

Another example includes a display and an operating system (OS). In this example the operating system is configured to identify whether an E-privacy filter capability exists on the display. In an instance where the E-privacy filter capability exists, the operating system is configured to instantiate an E-privacy filter driver that is configured to allow an entity (e.g., application) presenting content on the display to control a state of the E-privacy filter.

This summary is intended to provide a very brief explanation of some of the present concepts and is not intended to be limiting or all-encompassing of the concepts described and claimed in this disclosure.

### BRIEF DESCRIPTION OF THE DRAWINGS

The accompanying drawings illustrate implementations of the concepts conveyed in the present disclosure. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced.

FIGS. 1A-1C show example scenarios to which some of the present display privacy concepts can be applied.

FIGS. 2, 4, and 8 show example flowcharts for display privacy concepts in accordance with some implementations.

FIG. 3 and 5-7 show example systems for accomplishing display privacy concepts in accordance with some implementations.

### DETAILED DESCRIPTION

This description relates to enhancing privacy of visual content displayed for a user. Computer users spend hours every day looking at content displayed by their computing devices, such as notebook computers, smartphones, etc. In many work settings and especially public settings, content intended and displayed for a user is visible to other people in the user's vicinity. Sometimes the user is looking at non-sensitive (e.g., public) content, such as scrolling through news sites on the internet. In these scenarios, unintended viewers seeing the displayed content may not matter. In other cases, the user is viewing sensitive (e.g., private) content, such as private financial records, confidential work information, etc. Limiting unintended viewers'ability to see this private content is increasingly important.

The present concepts relate to an electronic privacy filter that is incorporated in the device's display. The electronic privacy filter has an ‘on’ or ‘active’ state that limits the viewing angle range of content displayed on the device's display and an ‘off’ state for normal viewing (e.g., a normal or wider viewing angle range). (In this document ‘electronic privacy’ is used interchangeably with ‘E-privacy’.)

The present concepts provide a technical solution that indicates to software (e.g., a program or application) presenting content on the device whether the device has an electronic privacy filter capability. The technical solution then allows the software to automatically set the state of the electronic privacy filter when presenting its content on the display.

This technical solution improves over existing attempts to address this problem. For instance, separate privacy filters exist that a user can carry with them and position over their display if they so choose. However, these filters are inconvenient for the user to carry and the user may forget to employ them. Further, sensitive content could be displayed on the device before the user realizes it is sensitive and fumbles around trying to find and deploy the separate privacy filter on the device. The present technical solution is also superior to existing electronic privacy filters on devices because those existing electronic privacy filters rely on the user to manually turn them on or off. The user can forget to turn them on when viewing sensitive content, thereby rendering them ineffective. In contrast, the present technical solution allows the software that is presenting the content to automatically set the state of the electronic privacy filter and thereby free the user from the burden. This solves the technical problem of eliminating inadvertent viewing by unintended viewers if the user forgets to turn the electronic privacy filter on or is delayed in doing so.

### Example Scenarios

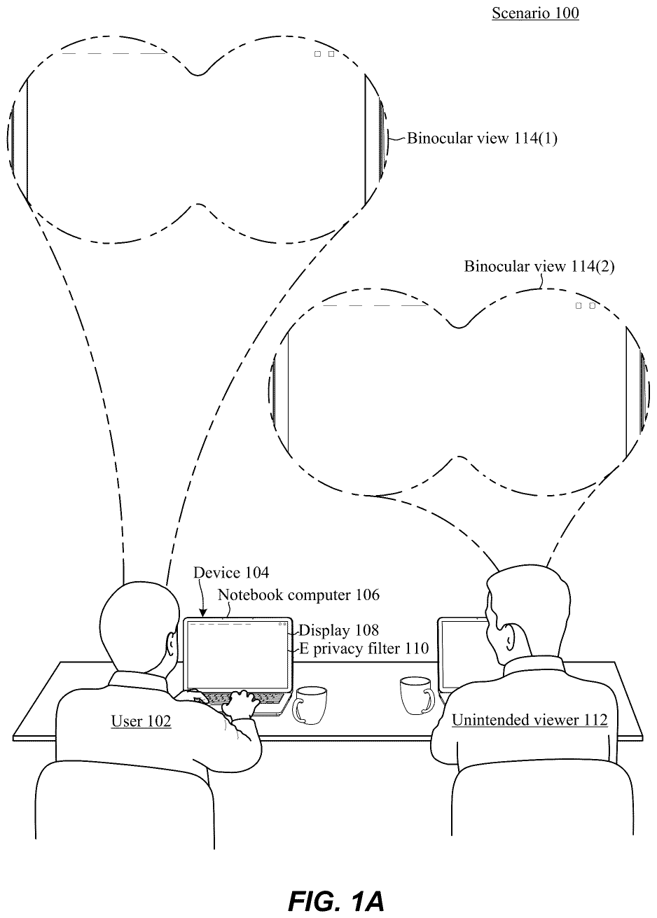

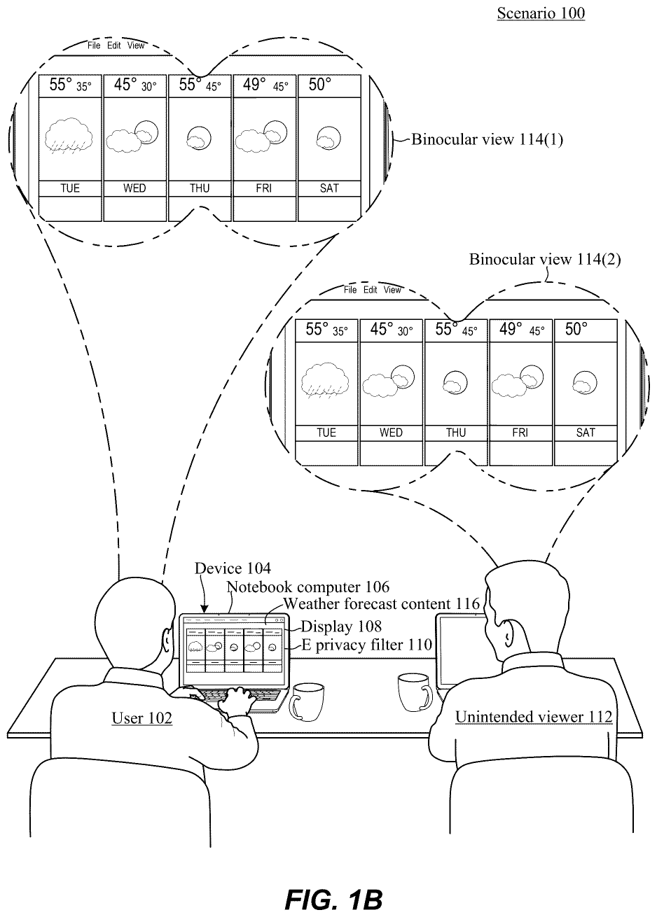

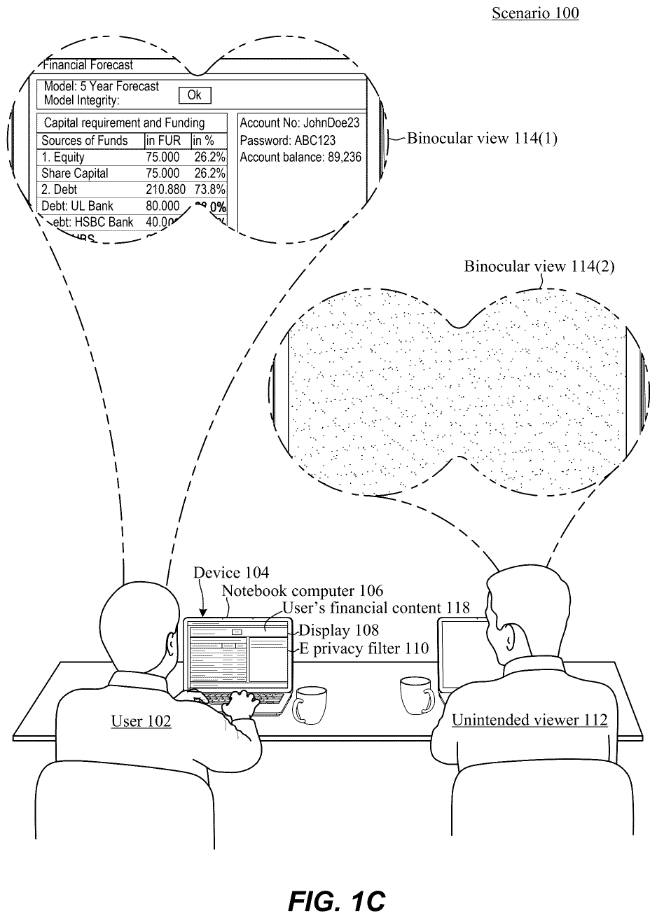

FIGS. 1A-1C collectively illustrate an example use case scenario 100 enabled by the present concepts. FIG. 1A shows a user 102 sitting down in a public coffee shop and starting up his device 104 in the form of notebook computer 106. The notebook computer 106 includes a display or screen 108. Assume for purposes of explanation that this notebook computer 106 includes an electronic privacy filter (E-privacy filter) 110 in its display 108. Note that the electronic privacy filter 110 is part of the layers of the display 108 and is not readily visible when looking at the device but would be visible if the display were taken apart and examined. Rather than seeing the electronic privacy filter 110 directly, one sees the effects of the electronic privacy filter 110 on content presented on the display 108.

In the ‘on’ state, the electronic privacy filter 110 limits a viewing angle range for content presented on the display 108. Generally, the viewing angle range of the electronic privacy filter 110 is about 25 or 30 degrees on each side (e.g., left and right) of a vertical plane extending perpendicularly to the display 108. When viewed from within the viewing angle range, content presented on the display looks similar whether the electronic privacy filter 110 is in the ‘on’ state or the ‘off’ state. In contrast, when viewed from outside the viewing angle range, when the electronic privacy filter 110 is off, content appears as would be expected. However, when the electronic privacy filter 110 is on, content is not readily discernable. Instead, the display appears very dim and/or has a striped or mottled appearance through which details of the content are not readily apparent.

Note that various electronic privacy filter 110 technologies have different viewing angle ranges and create different display appearances outside of the viewing angle ranges. The present concepts are applicable to these various electronic privacy filter 110 technologies. In one example display technology, the electronic privacy filter includes micro-louvers in the layers of the display. The micro-louvers affect light leaving the display. The micro-louvers and/or the backlight of the display can be controlled to create the ‘on’ state where the viewing angle is limited and the ‘off’ state where the viewing angle is normal (e.g., wider).

Assume for purposes of explanation, that user 102 is within the viewing angle range and that an unintended viewer 112 is outside the viewing angle range. Note that ‘binocular view’ 114(1) is intended to represent what user 102 sees when looking at content presented on display 108 and ‘binocular view’ 114(2) is intended to represent what unintended viewer 112 sees when looking at content presented on display 108.

Looking at FIG. 1A, assume for purposes of explanation that user 102 selects to view a weather forecast for his location. For instance, the selection could entail launching a weather application or program on the device 104. In this case, the weather application determines that electronic privacy filtering is not needed and automatically turns the electronic privacy filter 110 to the off state.

FIG. 1B shows resultant weather forecast content 116 generated by the weather application. In this example, the weather forecast content 116 represents non-sensitive content. In this case, both the user 102 and the unintended viewer 112 are able to see the weather forecast content 116. This is evidenced in that both binocular view 114(1) (e.g., what the user 102 sees) and binocular view 114(2) (e.g., what the unintended viewer 112 sees) match the weather forecast content 116 presented on the display 108.

Now, assume that user 102 wants to view his retirement portfolio and launches a financial program. The financial program can include instructions to maintain viewing privacy. As such, the financial program can automatically turn on electronic privacy filter 110 before presenting content on the display 108. The results are shown in FIG. 1C.

FIG. 1C shows the user's financial content 118 presented on the display 108. In this example, the user's financial content 118 represents sensitive content. The electronic privacy filter 110 is in the ‘on’ state and is thus limiting the viewing angle range of the sensitive content. This is evidenced in that the binocular view 114(1) (e.g., what the user 102 sees) matches the user's financial content 118 presented on the display 108. In contrast, binocular view 114(2) (e.g., what the unintended viewer 112 sees) is different. In this case, the unintended viewer 112 essentially sees a blank or indiscernible display 108. This content protection is achieved automatically without the user having to manually activate the privacy filter. This technical solution offers greater security and convenience to the user than existing technologies. Note that the application can determine whether to employ the E-privacy filter and automatically do so without any user involvement.

The description above explains some of the technical solutions offered by the present concepts. The description below provides example techniques for accomplishing these technical solutions.

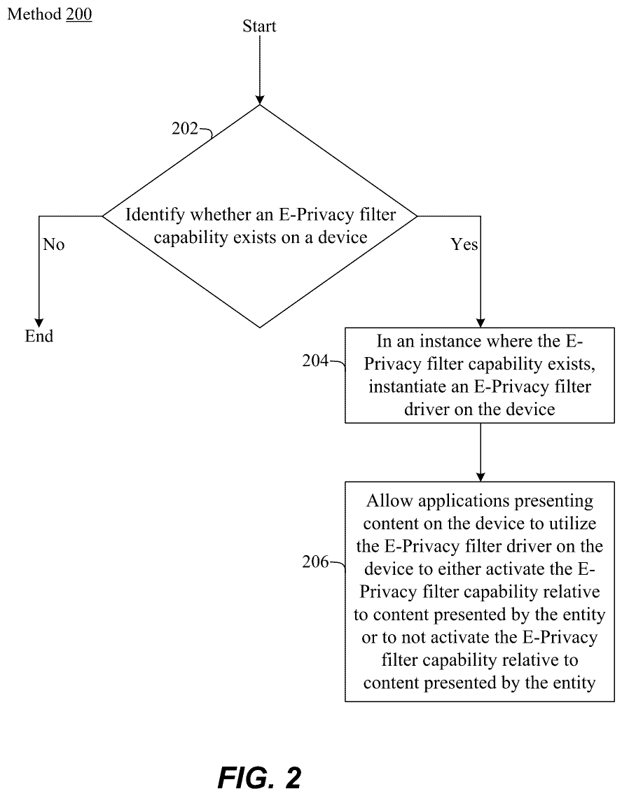

FIGS. 2-4 collectively describe example systems and methods/techniques for accomplishing the technical solutions described above relative to FIGS. 1A-1C.

FIG. 2 shows a broad example method 200 for accomplishing the technical solutions described above relative to FIGS. 1A-1C. Method 200 starts by identifying (e.g., detecting) whether an E-privacy filter capability exists on a device at block 202. For instance, the E-privacy filter can be built into the display that is incorporated into the device and thus provides the E-privacy filter capability. If the device does not have E-privacy filter capability the method ends. If the device does have an E-privacy filter capability, the method proceeds to block 204. In an instance where the E-privacy filter capability exists on the device, the method instantiates an E-privacy filter driver on the device. The E-privacy filter driver can allow software on the device to be aware of and control the E-privacy filter.

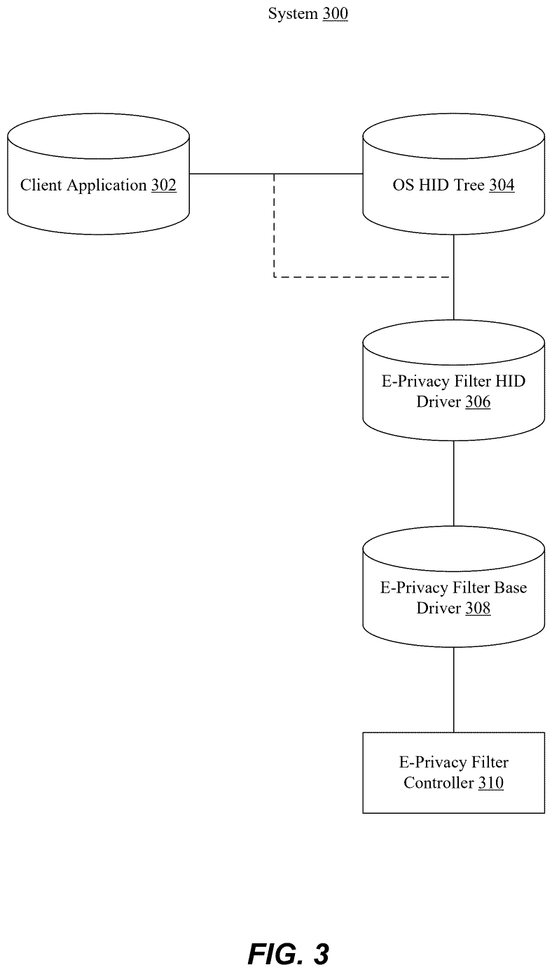

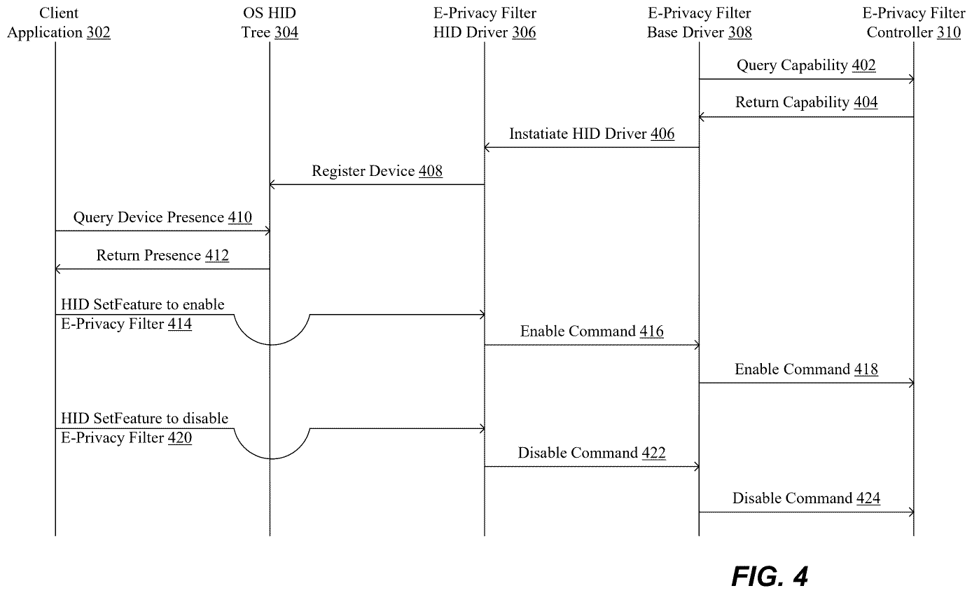

At 206, the method allows applications presenting content on the device to utilize the E-privacy filter driver on the device to either activate the E-privacy filter capability relative to content presented by the entity or to not activate the E-privacy filter capability relative to content presented by the entity. This selective activation provides the functionality described above relative to FIGS. 1B and 1C. As used here, the term ‘entity’ can include a program, application, browser, etc. The aspects introduced relative to FIG. 2 are described in more detail below relative to FIGS. 3-4.

FIGS. 3-4 collectively illustrate example systems and methods for accomplishing the concepts described above relative to FIGS. 1A-1C and 2. FIG. 3 shows a system 300 that includes components including a client application 302 (e.g., an example entity), an OS HID tree 304, an E-privacy filter HID driver 306, an E-privacy filter base driver 308, and an E-privacy filter controller 310. In this case, the client application 302, the OS HID (ACPI) tree 304, the E-privacy filter HID driver 306, and the E-privacy filter base driver 308 are software components, while the E-privacy filter controller 310 is a hardware component. HID stands for human interface device and is a standard used to create identifiers for peripheral devices/components that uniquely identify components of a device by class. Operating systems can use HID to discover, configure, and manage power of peripheral devices (e.g., components). In this case, the E-privacy filter can be treated as a peripheral component that is easily controlled through the pre-established HID standards. ACPI stands for advanced configuration and power interface. ACPI is an open standard that operating systems can use to discover and configure hardware components. ACPI allows the OS to perform power management and status monitoring of the hardware components. OS HID Tree 304 uses ACPI for device discovery and configuration enablement for the E-privacy filter components.

The system 300 allows a single operating system version to function with devices that have E-privacy filter capabilities and with devices that do not have E-privacy filter capabilities. Traditional techniques create separate operating systems for each class of devices (e.g., one operating system version for devices that include an E-privacy filter capability and another operating system version for devices that do not include the E-privacy filter capability). This traditional approach is resource intensive in that it requires writing and testing two different operating system versions. Further, by introducing and maintaining two versions, reliability of both versions is diminished. Further still, with existing technologies, the presence or absence of the E-privacy filter capabilities is opaque (e.g., undiscoverable) to the programs/applications working with the operating system. With these traditional technologies, the user can manually turn the E-privacy filter on or turn it off, but the application does not know of the capability or the state.

The present concepts provide a technical solution where a single version of the operating system works with both types of devices (e.g., devices that have E-privacy filter capabilities and devices that do not have E-privacy filter capabilities). This technical solution utilizes less resources, is more reliable, and produces an enhanced user experience over existing solutions. Further, the present concepts provide an additional technical solution in that they allow programs to discover (e.g., become aware of) the presence or absence of the device's E-privacy filter capabilities. The present concepts work with any type of operating system, such as Windows brand operating system, Android brand operating system, and iOS brand operating system, among others.

FIG. 4 shows actions that can be taken by the components of system 300 to accomplish methods consistent with method 200 of FIG. 2. In this implementation, the components involved are the client application 302, OS HID tree 304, E-privacy filter HID driver 306, E-privacy filter base driver 308, and E-privacy filter controller 310.

In this case, the actions start with E-privacy filter base driver 308 seeking whether E-privacy filter controller 310 has E-privacy filter capability at 402. In some implementations, the ‘seeking’ entails a query. In other implementations, the seeking involves seeking an indirect discovery. Both of these scenarios are described below. In the illustrated configuration, the E-privacy filter controller 310 responds with its capabilities (e.g., returns capabilities 404). For example, the response can entail an affirmative response (e.g., yes, I have E-privacy filter capabilities) or a negative response (e.g., no I do not have E-privacy filter capabilities).

Note that in this implementation, no response from the E-privacy filter controller 310 can be treated as a negative response. For instance, if the E-privacy filter base driver 308 does not get a response from the E-privacy filter controller 310 within a predefined period of time, the E-privacy filter base driver 308 may repeat the query again. If no response is received the second time (and/or some other predefined number of times), the E-privacy filter controller 310 can treat that condition the same as (e.g., equivalent to) a negative response. The reasoning for this is that if the device does not have an E-privacy filter, it will not have an E-privacy filter controller 310 to respond to the query. Thus, if the E-privacy filter base driver 308 receives a negative response from the E-privacy filter controller 310 or does not receive a response, the method interprets that as an indication that an E-privacy filter is not present and the method can end at that point. However, for purposes of explanation, assume that the E-privacy filter base driver 308 receives an affirmative response from the E-privacy filter controller 310 that it (e.g. the display) does have E-privacy filter capability.

When the E-privacy filter base driver 308 receives an affirmative response from the E-privacy filter controller 310, the E-privacy filter base driver 308 instantiates the E-privacy filter HID driver 306 at 406. In turn, the E-privacy filter HID driver 306 registers the device (e.g., the E-privacy filter controller 310) at 408 with the OS HID tree 304. Stated another way, the OS HID Tree 304 registers the E-privacy filter as an OS device.

Any time after the E-privacy filter controller 310 is registered, the client application 302 can query device (e.g., E-privacy filter controller 310) presence at 410. When the OS HID tree 304 receives the query from the client application 302, it returns the presence at 412 as the device (e.g., E-privacy filter controller 310) was previously registered, and is presently registered at 408, with the OS HID tree 304. This can be viewed as a call from the client application to the operating system. The E-privacy filter components are registered with the operating system via the OS HID tree 304 and thus the operating system returns an affirmative answer to the client application. At this point, the client application 302 is aware that the device includes the E-privacy filter capability because of the registered E-privacy filter controller 310.

Conversely (e.g., alternatively), if the E-privacy filter base driver 308 identified the device did not have an E-privacy filter, then it would not have instantiated the E-privacy filter HID driver 306. Thus, the E-privacy filter would not be registered with the OS HID tree 304, and when the client application queried about the E-privacy filter, the OS HID tree 304 would respond negatively (e.g., not present).

For purposes of explanation, assume that the E-privacy filter is present and registered. The client application 302 can now decide whether to invoke the E-privacy filter capability or not. For purposes of explanation, assume the client application is going to display sensitive content and, as such, activates (e.g., turns on) the E-privacy filter controller 310. Towards this end, the client application 302 can enable HID SetFeature to enable E-privacy filter at 414 in communication with the E-privacy filter HID driver 306. Stated another way, if the E-privacy filter device is present at the OS level, the client application can enable/disable the E-privacy filter with the HID SetFeature message. The E-privacy filter HID driver 306 can responsively send an enable command at 416 to the E-privacy filter base driver 308. In turn, the E-privacy filter base driver 308 can send an enable command at 418 to the E-privacy filter controller 310, which in turn activates or turns on the E-privacy filter in the display. Thus, the client application can selectively and indirectly control the E-privacy filter by causing other components that support the E-privacy filter to directly control the state of the E-privacy filter.

At a subsequent point, the client application 302 can decide to deactivate (e.g., turn off) the E-privacy filter controller 310. Towards this end, the client application 302 can disable the HID SetFeature to disable the E-privacy filter at 420 in communication with the E-privacy filter HID driver 306. The E-privacy filter HID driver 306 can responsively send a disable command at 422 to the E-privacy filter base driver 308. In turn, the E-privacy filter base driver 308 can send a disable command at 424 to the E-privacy filter controller 310, which turns off the E-privacy filter and the display returns to a normal viewing angle range.

To summarize some of the aspects described above relative to FIG. 4, these methods allow a single version of an operating system to work with computing devices that have E-privacy filters incorporated in their displays and those that do not have E-privacy filters. The operating system includes and/or interacts with the E-privacy filter base driver 308. The E-privacy filter base driver 308 identifies whether the device has an E-privacy filter indirectly by checking for the presence of a corresponding E-privacy filter controller 310. If the E-privacy filter base driver 308 determines (e.g., identifies) the device includes an E-privacy filter, then the E-privacy filter base driver 308 instantiates the E-privacy filter HID driver 306. In turn the E-privacy filter HID driver 306 is involved in subsequent steps of the method where an application 302 can turn on or turn off the E-privacy filter controller 310 and hence the E-privacy filter.

One of the inventive aspects described above relates to the novel E-privacy filter base driver 308. When the E-privacy filter base driver 308 identifies the presence of the E-privacy filter, E-privacy filter base driver 308 can instantiate the E-privacy filter HID driver 306, which can register the E-privacy filter on the OS HID tree 304. The OS HID tree 304 provides a standard (non-proprietary) interface that can be discovered by the client application. This allows the client application 302 to then employ the E-privacy filter or not. These inventive concepts enhance the software scalability, and promote E-privacy filter deployment throughout the software ecosystem, resulting in device security and privacy control enhancement.

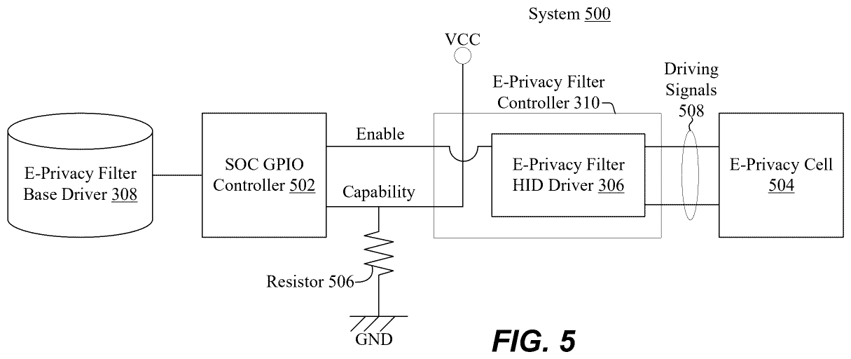

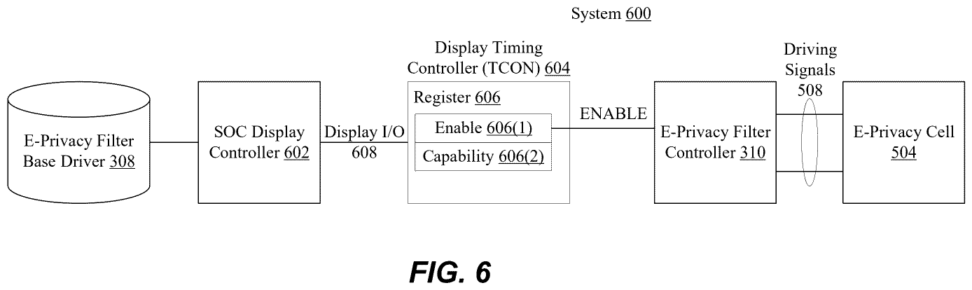

FIGS. 5 and 6 show two example configurations for achieving the functionality described relative to FIG. 4.

FIG. 5 shows example system 500 that includes E-privacy filter base driver 308, a SoC GPIO controller 502, E-privacy filter HID driver 306, and E-privacy cell 504. In this system, the E-privacy cell 504 represents the E-privacy filter in the display. VCC is the supply voltage, which is connected to the SoC GPIO controller 502 and separated from ground (GND) by a resistor 506.

GPIO stands for general-purpose input/output. System on a Chip (SoC) integrated circuits can use GPIO pins for peripheral devices/components. The SoC GPIO controller 502 can provide a variety of functions for peripheral devices, including interrupts, input signaling, and output signaling for the peripheral devices over the pins. In this case, some of the pins are used to connect the SoC GPIO controller 502 to E-privacy filter HID driver 306.

In this implementation, the E-privacy filter controller 310 is coupled to the E-privacy filter HID driver 306 via GPIO pins or lines. E-privacy filter controller 310 electrically drives E-privacy cell 504 with driving signals 508 (e.g., turns the E-privacy filter on or off).

Two GPIO lines are connected to E-privacy filter HID driver 306. One GPIO line is used as an ENABLE signal for E-privacy filter HID driver 306. When the GPIO is asserted, E-privacy filter HID driver 306 drives the E-privacy filter, or vice versa. The other GPIO line is pulled-down to GND, and connected to VCC in the E-privacy filter controller 310. When there is an E-privacy filter on the device, the GPIO line is tied up to VCC, signaling the E-privacy filter presence to E-privacy filter base driver 308 by SOC GPIO controller 502. On the other hand, when there is no E-privacy filter on the device, the GPIO is tied up with GND as there is no E-privacy filter controller 310, signaling no E-privacy filter presence to E-privacy filter base driver 308.

To summarize some of the concepts described above, one way for the E-privacy filter base driver 308 to determine if the display includes an E-privacy filter is to sample the voltage on the capability pin associated with the E-privacy filter controller 310. If the voltage is high, the device includes an E-privacy filter controller 310 and hence the display includes an E-privacy filter. If the voltage on the capability pin is low, then the display does not include an E-privacy filter. With this information, the E-privacy filter base driver 308 can take appropriate action, such as when the voltage is high (e.g., display includes an E-privacy filter), then the E-privacy filter base driver 308 can instantiate the E-privacy filter HID driver 306 of FIG. 3.

Thus, in this example, the E-privacy filter base driver 308 identifies whether the display includes an E-privacy filter driver without issuing a query and waiting for a response. Instead, the E-privacy filter base driver 308 samples a voltage on a GPIO pin that would supply power to the E-privacy filter controller 310. If there is an E-privacy filter controller 310 connected to the pin the sampled voltage will be high. This indicates to the E-privacy filter base driver 308 that the display includes an E-privacy filter. If the sampled voltage is low, then there is no E-privacy filter controller 310 and hence no E-privacy filter.

FIG. 6 shows example system 600 that includes E-privacy filter base driver 308, a SoC display controller 602, a display timing controller (TCON) 604 with a register 606, E-privacy filter controller 310, and E-privacy cell 504.

System 600 shows another design instance of E-privacy filter base driver 308 interacting with hardware. In this design, TCON 604 acts as a primary E-privacy filter controller. TCON 604 has two registers 606: an enable register 606(1) and a capability register 606(2). The enable register 606(1) provides an ENABLE signal to the E-privacy filter controller 310. In turn, the E-privacy filter controller 310 drives the E-privacy cell 504 with driving signals 508. The capability register 606(2) exposes the E-privacy filter capability.

The capability register 606(2) (CAPABILITY signal) is populated by board level configuration of the display, flagged when the E-privacy filter is present, and unflagged when E-privacy filter is not present. The E-privacy filter base driver 308 uses the TCON 604 to access the registers 606. One potential benefit of this design is that it does not employ GPIO, and instead uses the display I/O 608 as the control signal. This eases the system integration, such as by utilizing fewer pins.

Viewed from one perspective, devices with displays have a TCON 604 that controls the display. Further, if the display has an E-privacy filter it will have an E-privacy filter controller 310. The TCON 604 will either include the E-privacy filter controller 310 as a subset of its functionality or be in communication with the E-privacy filter controller 310. Thus, a call (e.g., query) to the TCON 604 about the E-privacy filter controller 310 will receive an informed response. This provides another technique for the E-privacy filter base driver 308 to identify whether the display includes an E-privacy filter.

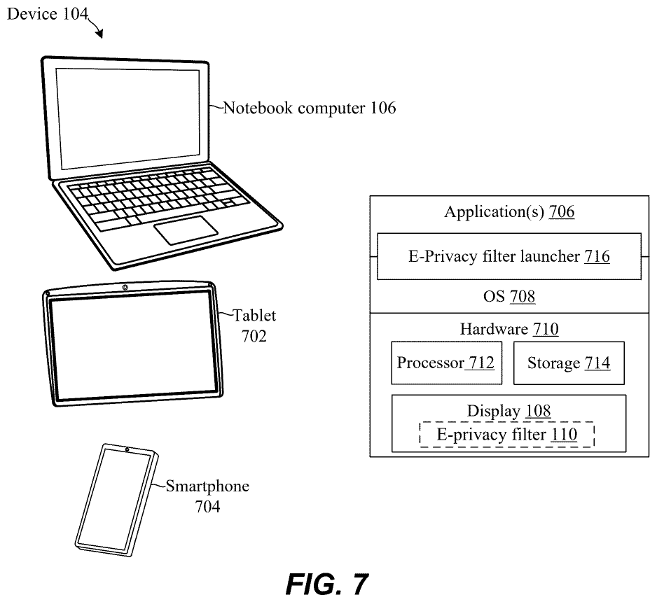

FIG. 7 shows another example system 700 that includes several example devices 104, including notebook computer 106, tablet 702, and smart phone 704, among others.

The devices 104 can include applications 706, operating system (OS) 708, and hardware 710. The hardware 710 can include a processor 712, storage 714, and display 108. The display 108 may or may not include E-privacy filter 110, which is shown in ghost to indicate that it may or may not be present.

An E-privacy filter launcher 716 can be configured to identify whether the E-privacy filter 110 is present on the device. If the E-privacy filter 110 is present, the E-privacy filter launcher 716 can take actions to surface this information to the applications 706. Individual applications 706 can then determine whether to activate or inactivate the E-privacy filter for the content they present. If the E-privacy filter 110 is not present, the E-privacy filter launcher 716 does not take the actions. Examples of how this can be achieved are described above relative to FIGS. 2-6.

In another example, the E-privacy filter launcher 716 can identify whether an E-privacy filter capability exists on the display. In an instance where the E-privacy filter capability exists, the E-privacy filter launcher 716 can instantiate an E-privacy filter driver that is configured to allow an application presenting content on the display to control a state of the E-privacy filter. Of note, the E-privacy filter launcher 716 allows a single version of the operating system to work whether the display includes the E-privacy filter 110 or not. This obviates the need to have a first version of the OS for devices that include the E-privacy filter and a different second version of the OS for devices that do not include the E-privacy filter.

The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage, such as storage that can be internal or external to the device. The storage can include any one or more of volatile or non-volatile memory, hard drives, flash storage devices, and/or optical storage devices (e.g., CDs, DVDs, etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU or CPUs). The program code can be stored in one or more computer-readable memory devices, such as computer-readable storage media. The features and techniques of the component are platform-independent, meaning that they may be implemented on a variety of commercial computing platforms having a variety of processing configurations.

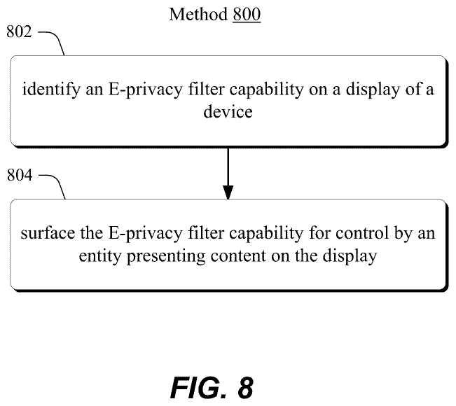

Several example techniques are described in detail above. FIG. 8 shows another example E-privacy filter launcher method or technique 800.

Block 802 can identify an E-privacy filter capability on a display of a device. Various ways this can be achieved are described above relative to FIGS. 4-6.

Block 804 can surface the E-privacy filter capability for control by an entity presenting content on the display. Various ways this can be achieved are described above relative to FIGS. 4-6. The entity can be local on the device that includes the display and the E-privacy filter (e.g., a client application running locally on the device) or the entity can be remote from the device (e.g., a web site or a browser). This method provides a technical solution that exposes the presence of the E-privacy filter to content presenting entities and allows the content presenting entities to selectively and automatically control the state of the E-privacy filter.

### Additional Examples

Various examples are described above. Additional examples are described below. One example includes a system comprising a display for presenting visual content and an electronic privacy filter base driver configured to identify that the display includes an electronic privacy filter that can be controlled to limit a viewing angle range of the display and configured to instantiate, responsive to the identified electronic privacy filter, an electronic privacy filter human interface driver, the electronic privacy filter human interface driver configured to register the electronic privacy filter and an application configured to generate content for presentation on the display and to identify the registered electronic privacy filter and further configured to cause the electronic privacy filter human interface driver to selectively control the electronic privacy filter to limit the viewing angle range of the display while the content is presented.

Another example can include any of the above and/or below examples where the electronic privacy filter base driver is configured to query an E-privacy filter controller about the electronic privacy filter.

Another example can include any of the above and/or below examples where the electronic privacy filter base driver is configured to interpret both a negative response from the E-privacy filter controller and no response from the E-privacy filter controller as an indication the display does not include the electronic privacy filter.

Another example can include any of the above and/or below examples where the electronic privacy filter base driver is configured to sample a voltage on an input/output (I/O) pin associated with an E-privacy filter controller about the electronic privacy filter.

Another example can include any of the above and/or below examples where the electronic privacy filter base driver is configured to query a display timing controller about a presence of an E-privacy filter controller.

Another example can include any of the above and/or below examples where if the display includes the electronic privacy filter, the display timing controller includes the E-privacy filter controller.

Another example can include any of the above and/or below examples where the electronic privacy filter base driver identifies that the display does not include an electronic privacy filter, the electronic privacy filter base driver is configured not to instantiate the electronic privacy filter human interface driver.

Another example can include any of the above and/or below examples where the electronic privacy filter human interface driver is configured to register the electronic privacy filter with an operating system human interface tree.

Another example can include any of the above and/or below examples where the application is configured to identify the registered electronic privacy filter on the operating system human interface tree.

Another example can include any of the above and/or below examples where the limited viewing angle range of the content when the electronic privacy filter is activated by the application extends 30 degrees left and right of a vertical plane extending perpendicularly to the display.

Another example includes a device-implemented method, comprising identifying an electronic privacy (E-privacy) filter capability on a display of a device and surfacing the E-privacy filter capability for control by an entity presenting content on the display.

Another example can include any of the above and/or below examples where the entity is local on the device or remote from the device.

Another example can include any of the above and/or below examples where the entity comprises a client application running locally on the device.

Another example can include any of the above and/or below examples where the identifying comprises querying a component that supports the E-privacy filter capability.

Another example can include any of the above and/or below examples where the identifying treats no response from the component equivalent to a negative response from the component.

Another example can include any of the above and/or below examples where the identifying comprises checking a voltage on a line to a component that supports the E-privacy filter capability.

Another example can include any of the above and/or below examples where the method further comprises selectively controlling a viewing angle range of the display with the E-privacy filter while the entity presents content on the display.

Another example includes a device comprising a display and an operating system configured to identify whether an electronic privacy (E-privacy) filter capability exists on the display and in an instance where the E-privacy filter capability exists, instantiate an E-privacy filter driver that is configured to allow an application presenting content on the display to control a state of the E-privacy filter.

Another example can include any of the above and/or below examples where the identifying comprises attempting to detect a component that supports operation of the E-privacy filter capability.

Another example can include any of the above and/or below examples where alternatively if the operating system identifies the E-privacy filter capability does not exist, the operating system does not instantiate an E-privacy filter driver.

### Conclusion

Although techniques, methods, devices, systems, etc., pertaining to enhancing security of content displayed for a user are described in language specific to structural features and/or methodological acts, it is to be understood that the subject matter defined in the appended claims is not necessarily limited to the specific features or acts described. Rather, the specific features and acts are disclosed as example forms of implementing the claimed methods, devices, systems, etc.

1. A system, comprising:
a display for presenting visual content; and,
an electronic privacy filter base driver configured to identify that the display includes an electronic privacy filter that can be controlled to limit a viewing angle range of the display and configured to instantiate, responsive to the identified electronic privacy filter, an electronic privacy filter human interface driver;
the electronic privacy filter human interface driver configured to register the electronic privacy filter; and,
an application configured to generate content for presentation on the display and to identify the registered electronic privacy filter and further configured to cause the electronic privacy filter human interface driver to selectively control the electronic privacy filter to limit the viewing angle range of the display while the content is presented.

2. The system of claim 1, wherein the electronic privacy filter base driver is configured to query an E-privacy filter controller about the electronic privacy filter.

3. The system of claim 2, wherein the electronic privacy filter base driver is configured to interpret both a negative response from the E-privacy filter controller and no response from the E-privacy filter controller as an indication the display does not include the electronic privacy filter.

4. The system of claim 1, wherein the electronic privacy filter base driver is configured to sample a voltage on an input/output (I/O) pin associated with an E-privacy filter controller about the electronic privacy filter.

5. The system of claim 1, wherein the electronic privacy filter base driver is configured to query a display timing controller as to a presence of an E-privacy filter controller.

6. The system of claim 5, wherein if the display includes the electronic privacy filter, the display timing controller includes the E-privacy filter controller.

7. The system of claim 1, wherein filter human interface driver is further configured to allow the application to subsequently selectively control the electronic privacy filter to restore the viewing angle range of the display when the content is no longer presented.

8. The system of claim 1, wherein the electronic privacy filter human interface driver is configured to register the electronic privacy filter with an operating system human interface tree.

9. The system of claim 8, wherein the application is configured to identify the registered electronic privacy filter on the operating system human interface tree.

10. The system of claim 1, wherein the limited viewing angle range of the display when the electronic privacy filter is activated by the application extends 30 degrees left and right of a vertical plane extending perpendicularly to the display.

11. A device-implemented method, comprising:
identifying an electronic privacy (E-privacy) filter capability on a display of a device; and,
surfacing the E-privacy filter capability for control by an entity presenting content on the display.

12. The method of claim 11, wherein the entity is local on the device or remote from the device.

13. The method of claim 12, wherein the entity comprises a client application running locally on the device.

14. The method of claim 13, wherein the identifying comprises querying a component that supports the E-privacy filter capability.

15. The method of claim 14, wherein the identifying treats no response from the component equivalent to a negative response from the component.

16. The method of claim 13, wherein the identifying comprises checking a voltage on a line to a component that supports the E-privacy filter capability.

17. The method of claim 13, further comprising selectively controlling a viewing angle range of the display with the E-privacy filter while the entity presents content on the display.

18. A device, comprising:
a display; and,
an operating system configured to:
identify whether an electronic privacy (E-privacy) filter exists on the display; and,
in an instance where the E-privacy filter exists, instantiate an E-privacy filter driver that is configured to allow an application presenting content on the display to control a state of the E-privacy filter.

19. The device of claim 18, wherein the identifying comprises attempting to detect a component that supports operation of the E-privacy filter.

20. The device of claim 18, wherein alternatively if the operating system identifies the E-privacy filter does not exist, the operating system does not instantiate an E-privacy filter driver.
